(19) United States
(12) Patent Application Publication
(10) Pub. No.: US 2012/0145325 A1
(43) Pub. Date: Jun. 14, 2012

(54) PLASMA APPARATUS

(75) Inventors: Hui-Ta Chen, Taichung City (TW); Chun-Hao Chang, Kaohsiung County (TW); Tung-Ying Lin, Kaohsiung City (TW); Ming-Hsien Ko, Chiayi County (TW)

(73) Assignee: INDUSTRIAL TECHNOLOGY RESEARCH INSTITUTE, Hsinchu (TW)

(21) Appl. No.: 13/044,570

(22) Filed: Mar. 10, 2011

(30) Foreign Application Priority Data
Dec. 9, 2010 (TW) 99143078

(51) Int. Cl. C23F 1/08; H05H 1/24

(52) U.S. Cl. 156/345.33

(57) ABSTRACT

A plasma apparatus including a chamber, an electrode set and a gas supplying tube set is provided. The chamber has a supporting table for supporting a substrate. The gas supplying tube set is disposed in the chamber and has a plurality of gas apertures. The gas supplying tube set is located between the supporting table and the electrode set.

### CROSS-REFERENCE TO RELATED APPLICATION

This application claims the priority benefit of Taiwan application serial no. 99143078, filed on Dec. 9, 2010. The entirety of the above-mentioned patent application is hereby incorporated by reference herein and made a part of this specification.

### BACKGROUND

1. Field of the Disclosure

The disclosure relates to a plasma apparatus. Particularly, the disclosure relates to an inductively coupled plasma (ICP) apparatus.

2. Description of Related Art

Plasma is ionised gas containing ions or electrodes and radicals, which has a wide application. Plasma treatment refers to that the gas is transformed to the plasma, and the plasma gas is deposited on a substrate, or the plasma gas is used for cleaning, coating, sputtering, plasma chemical vapor deposition, ion implantation, ashing or etching, etc. During operation of a commonly used plasma treatment apparatus, after a powerful electric filed is formed between two electrodes, the process gas supplied between the two electrodes is ionised or deionised to generate plasma.

Regarding a current research and development status of displays, large-scale displays and flexible displays are researched and developed, and during a commercialisation process of the displays, a most important issue thereof is a high uniformity problem of a large area substrate. Regarding conventional capacitively coupled plasma (CCP), a processing rate of the apparatus cannot be effectively improved due to a small density of the plasma, so that inductively coupled plasma (ICP) becomes a technique with a great potential. Since a plasma density of the ICP is relatively high, the ICP is generally referred to as a high density plasma source, and a system thereof is characterized by an inductively coupled coil capable of generating plasma. However, a design of a large area ICP may have following problems: (1) when a length of the coil is excessively long to cause a problem of standing wave, efficiency of energy transfer is influenced; (2) in case of a large area, uniformity of the plasma is hard to be adjusted, especially at the part of a coil edge, processes such as plasma assisted deposition or plasma assisted etching are limited.

According to Taiwan Patent No. TW 00449107, the coil is embedded in a dielectric layer, and the dielectric layer is disposed in a chamber at a position opposite to a substrate carrier. A shape of the dielectric layer can be adjusted to change an electric field coupling strength. However, according to such method, an appropriate dielectric material has to be sintered, so as to install the coil. Moreover, an additional cooling device has to be used for cooling of the coil in the dielectric material, which leads to a high cost. Since the coil is embedded in the dielectric layer, it is inconvenient for adjustment, and in case of the large area, it is difficult to sinter a large area dielectric layer, and embed the coil.

According to U.S. Pat. No. 7,338,577, the coil is designed according to a parallel and interlaced method, and a permanent magnet is used to improve the uniformity of the plasma. However, usage of the permanent magnet increases a complexity of the structure and cost of the apparatus. Moreover, the coil impacted by the plasma may generate particles, which may cause pollution of the process, so that frequent cleaning of the apparatus is required.

### SUMMARY OF THE DISCLOSURE

The disclosure is directed to a plasma apparatus, which may have a good fabrication yield in a large area fabrication process.

The disclosure provides a plasma apparatus including a chamber, an electrode set and a gas supplying tube set. The chamber has a supporting table for supporting a substrate. The gas supplying tube set is disposed in the chamber and has a plurality of gas apertures. The gas supplying tube set is located between the supporting table and the electrode set.

The plasma apparatus of the disclosure uses a gas field to adjust the uniformity of the plasma. Therefore, in a large size fabrication process of the plasma apparatus, a good fabrication yield thereof can be maintained.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a partial three-dimensional view of a plasma apparatus according to an exemplary embodiment of the disclosure.

FIG. 2 is a cross-sectional view of a plasma apparatus according to an exemplary embodiment of the disclosure.

FIG. 3 is a partial enlarged view of a gas supplying tube set of FIG. 1.

FIG. 4 is a schematic diagram of an electrode set of FIG. 1.

FIG. 5 is a schematic diagram illustrating a linear body of an electrode set of a plasma apparatus according to another exemplary embodiment of the disclosure.

FIG. 6 is a cross-sectional view of a plasma apparatus according to another exemplary embodiment of the disclosure.

### DETAILED DESCRIPTION OF DISCLOSED EMBODIMENTS

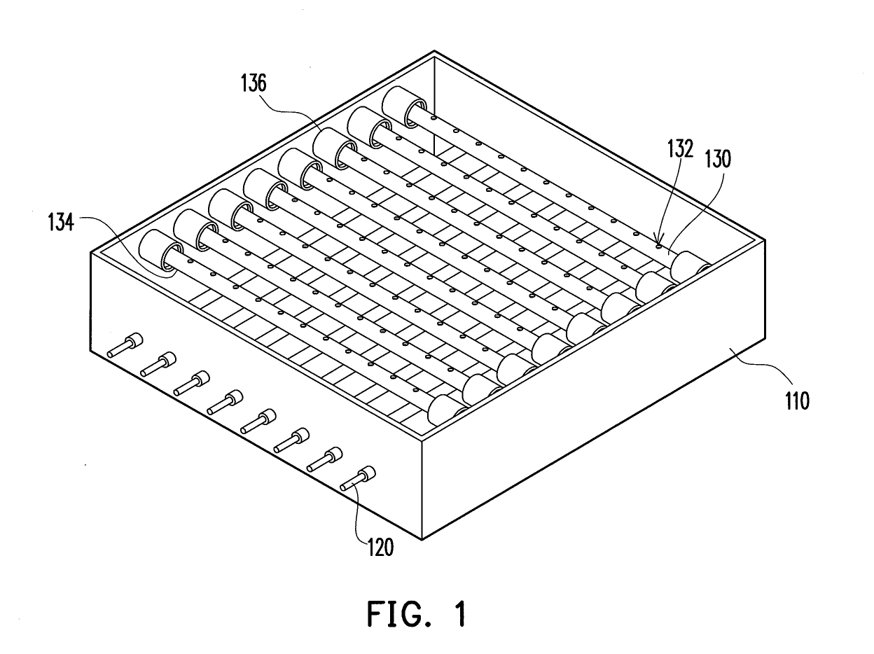

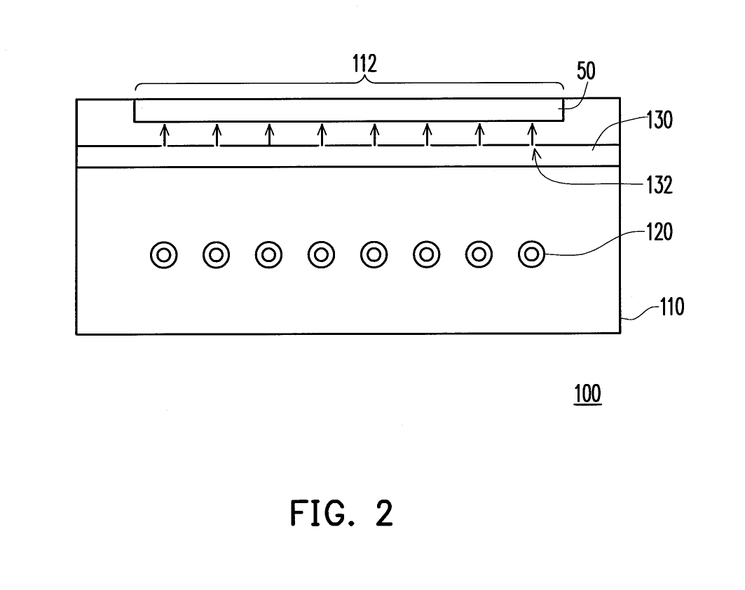

FIG. 1 is a partial three-dimensional view of a plasma apparatus according to an exemplary embodiment of the disclosure, and FIG. 2 is a cross-sectional view of the plasma apparatus according to an exemplary embodiment of the disclosure. Referring to FIG. 1 and FIG. 2, the plasma apparatus 100 includes a chamber 110, an electrode set 120 and a gas supplying tube set 130. The chamber 110 has a supporting table 112 for supporting a substrate 50. The gas supplying tube set 130 is located between the supporting table 112 and the electrode set 120. The gas supplying tube set 130 is disposed in the chamber 110 and has a plurality of gas apertures 132, where the gas apertures 132 are perpendicular to an axial direction of the gas supplying tube set 130, and the gas apertures 132 can be disposed in different rotation angles relative to the axial direction. Namely, in the present exemplary embodiment, the gas apertures 132 face to the supporting table 112, though in other embodiments, the gas apertures 132 may also face to side surfaces of the chamber 110 (i.e. left and right directions of FIG. 1), or face to the electrode set 120, which is not limited by the disclosure. In FIG. 1, the supporting table 112 and the substrate 50 of the chamber 110 are omitted.

In the plasma apparatus 100 of the present exemplary embodiment, by changing sizes, positions, a number and magnitude of a gas flow of the gas apertures 132, the plasma generated by the process gas under a function of an electric field of the electrode set 120 can evenly function on the substrate 50. In the present exemplary embodiment, a gas field generated by the necessary gas supplying tube set 130 in the plasma apparatus 100 is used to uniform the plasma, which has little influence on apparatus complexity and cost. Moreover, since the gas supplying tube set 130 is located between the supporting table 112 and the electrode set 120, after the process gas is transformed into the plasma, most of the plasma directly moves to the substrate 50 other than hitting the electrode set 120, so that generation of polluted particles is reduced, so as to improve the fabrication yield and reduce the cost required for cleaning the apparatus.

Referring to FIG. 2, the gas apertures 132 are located under the supporting table 112 due to a location of the gas supplying tube set 130. According to a conventional technique, the gas apertures are generally arranged on sidewalls of the chamber, i.e. the gas apertures and the supporting table are respectively located on two chamber walls connected and perpendicular to each other. However, in the present exemplary embodiment, the gas supplying tube set 130 passes through most of the space of the chamber, and the gas apertures 132 of the gas supplying tube set 130 are distributed in the space of the chamber, so that the gas field provided by the gas apertures 132 can be used to adjust the uniformity of the plasma. If the supporting table 112 is regarded as a plane, orthogonal projections of most of the gas apertures 132 relative to the plane may fall within a range of the supporting table 112. Sizes, positions, and a number of the gas apertures 132 can be determined after the sizes and relative positions of the substrate 50, the chamber 110 and the electrode set 120 are determined, so as to obtain a good fabrication yield.

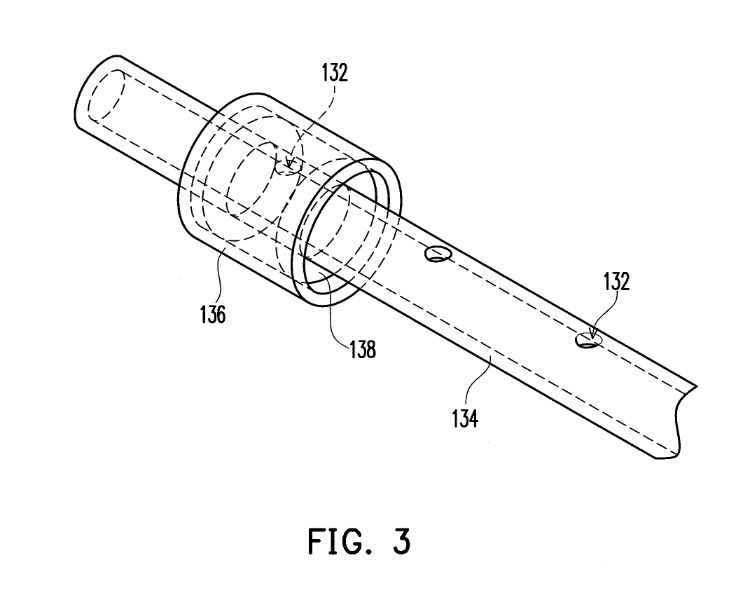

FIG. 3 is a partial enlarged view of the gas supplying tube set of FIG. 1. Referring to FIG. 1 and FIG. 3, the gas supplying tube set 130 of the present exemplary embodiment includes a plurality of gas supplying tubes 134 disposed in the chamber 110 in parallel. In other embodiments, the gas supplying tubes 134 may also have other shapes than a straight bar-shape, and are not limited to be parallel to each other. Moreover, the gas supplying tube set 130 further includes a plurality of shielding elements 136 movably sleeved on the gas supplying tubes 134 for shielding a part of the gas apertures 132. A number of the shielding elements 136 sleeved on each of the gas supplying tubes 134 can be increased or decreased according to a design requirement, and a number of the gas apertures 132 shielded by each of the shielding elements 136 can be single or plural. By configuring the shielding elements 136, positions and the number of the gas apertures 132 can be flexibly changed, so that when a size of the substrate 50 is changed, a suitable and uniform plasma distribution status can still be achieved. Moreover, during the plasma treatment, the chamber 110 is in a vacuum state. The gas supplying tube set 130 may further includes a plurality of washers 138 disposed between the shielding elements 136 and the gas supplying tubes 134 for isolating the gas from passing through, i.e. preventing the process gas flowing out from the gas apertures 134 from entering the chamber 110 through a place between the shielding elements 136 and the gas supplying tubes 134. A material of the gas supplying tube set 130 includes a dielectric material, so as to avoid changing a distribution of the electric field generated by the electrode set 120. For example, the material of the shielding elements 136 and the gas supplying tubes 134 can be quartz, and the material of the washers 138 can be rubber.

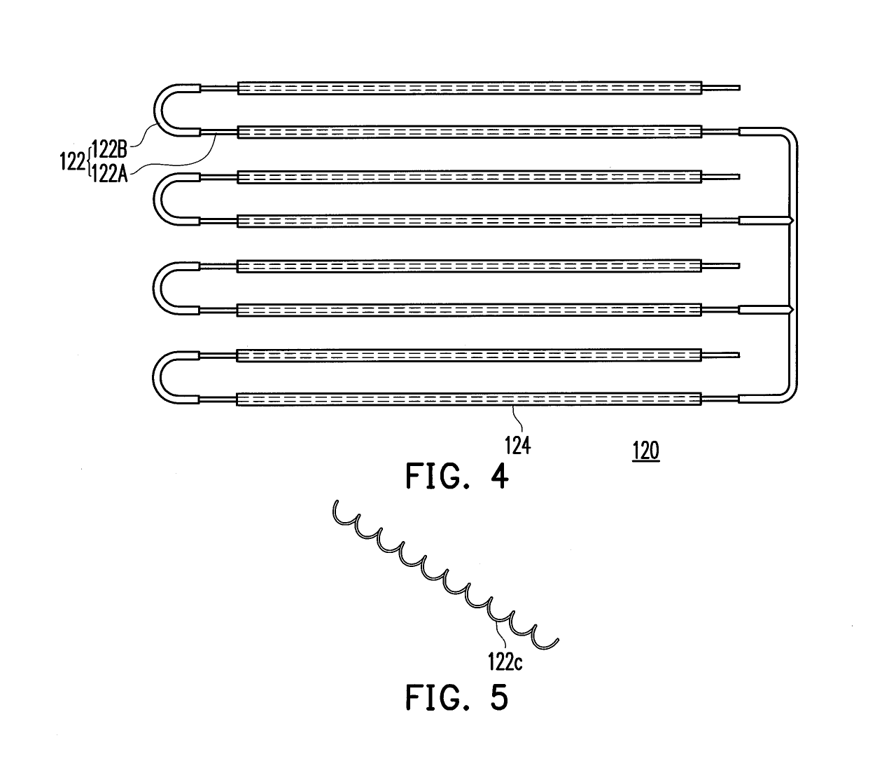

FIG. 4 is a schematic diagram of the electrode set of FIG. 1. Referring to FIG. 1 and FIG. 4, most part of the electrode set 120 is located in the chamber 110. Moreover, the electrode set 120 includes a metal body 122 and a plurality of dielectric sleeves 124, the dielectric sleeves 124 are sleeved on a part of the metal body 122 located in the chamber 110. A function of the dielectric sleeves 124 is to avoid damage of the metal body 122 due to hit of the plasma. When the electrode set 120 is totally located outside the chamber 110, usage of the dielectric sleeves 124 is unnecessary. A material of the metal body 122 is, for example, copper, aluminium, stainless steel or other metals, and a material of the dielectric sleeves 124 is, for example, quartz or other dielectric materials. The metal body 122 of the electrode set 120 includes a plurality of linear bodies 122A and a plurality of connection parts 122B. The linear bodies 122A are connected in parallel, i.e. the connection part 122B connects two adjacent linear bodies 122A, and one end of the linear body 122A that is not connected to the connection part 122B can be connected to ground. Moreover, referring to FIG. 1, the gas supplying tubes 134 of the gas supplying tube set 130 are arranged in parallel, and are disposed above the electrode set 120, where an axial direction of the gas supplying tubes 134 of the gas supplying tube set 130 is perpendicular to an axial direction of the dielectric sleeves 124 of the electrode set 120, though in other embodiments, the axial direction of the gas supplying tubes 134 and the axial direction of the dielectric sleeves 124 can be parallel or have other angles formed there between, which is not limited by the disclosure. Moreover, each of the linear bodies 122A has a straight line shape, though a linear body 122C of FIG. 5 has a spiral line shape.

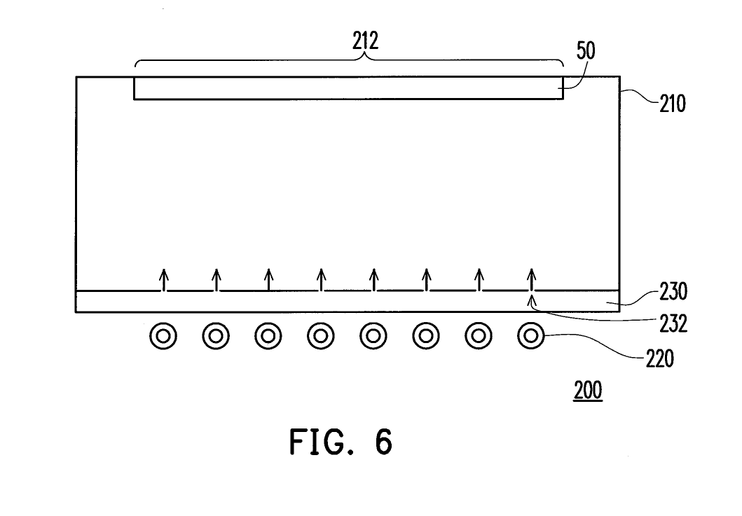

FIG. 6 is a cross-sectional view of a plasma apparatus according to another exemplary embodiment of the disclosure. Referring to FIG. 6, the plasma apparatus 200 of the present exemplary embodiment is similar to the plasma apparatus 100 of FIG. 2, and a difference there between is that an electrode set 220 is located outside a chamber 210. Since gas apertures 232 of a gas supplying tub set 230 are still located between a supporting table 212 and the electrode set 220, a gas field provided by the gas apertures 232 can still be used to ensure the plasma uniformly functions on the substrate 50. Moreover, the plasma apparatus 200 of the present exemplary embodiment also has the advantages of reducing generation of polluted particles, improving the fabrication yield and reducing cost required for cleaning the apparatus.

In summary, the plasma apparatus of the disclosure uses a gas field generated by the gas apertures between the supporting table and the electrode set to adjust uniformity of the plasma. Therefore, the plasma apparatus of the disclosure may have good plasma uniformity in a large size fabrication process without using a complicated structure, and may also reduce generation of polluted particles, so as to achieve a good fabrication yield.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A plasma apparatus, comprising:
a chamber, having a supporting table for supporting a substrate;
an electrode set; and
a gas supplying tube set, disposed in the chamber and having a plurality of gas apertures, and located between the supporting table and the electrode set.

2. The plasma apparatus as claimed in claim 1, wherein the gas apertures are perpendicular to an axial direction of the gas supplying tube set, and the gas apertures are capable of being disposed in different rotation angles relative to the axial direction.

3. The plasma apparatus as claimed in claim 1, wherein the gas supplying tube set comprises a plurality of gas supplying tubes arranged in the chamber in parallel.

4. The plasma apparatus as claimed in claim 3, wherein the gas supplying tube set further comprises a plurality of shielding elements movably sleeved on the gas supplying tubes for shielding a part of the gas apertures.

5. The plasma apparatus as claimed in claim 4, wherein the gas supplying tube set further comprises a plurality of washers disposed between the shielding elements and the gas supplying tubes for isolating gas from passing through.

6. The plasma apparatus as claimed in claim 1, wherein a material of the gas supplying tube set comprises a dielectric material.

7. The plasma apparatus as claimed in claim 1, wherein the electrode set is partially located in the chamber.

8. The plasma apparatus as claimed in claim 7, wherein the electrode set comprises a metal body and a plurality of dielectric sleeves, and the dielectric sleeves are sleeved on a part of the metal body located in the chamber.

9. The plasma apparatus as claimed in claim 1, wherein the electrode set is located outside the chamber.

10. The plasma apparatus as claimed in claim 1, wherein the electrode set comprises:
a plurality of linear bodies; and
a plurality of connection parts, connected between each two adjacent linear bodies,
wherein the linear bodies are connected in parallel.

11. The plasma apparatus as claimed in claim 10, wherein each of the linear bodies has a straight line shape.

12. The plasma apparatus as claimed in claim 10, wherein each of the linear bodies has a spiral line shape.
